(19) United States
(12) Patent Application Publication
(10) Pub. No.: US 2023/0153392 A1
(43) Pub. Date: May 18, 2023

(54) CONTROL DEVICE FOR PREDICTING A DATA POINT FROM A PREDICTOR AND A METHOD THEREOF

(71) Applicant: SIGNIFY HOLDING B.V., EINDHOVEN (NL)

(72) Inventors: ROHIT KUMAR, ACTON, MA (US); DAKSHA YADAV, BOSTON, MA (US); SHAHIN MAHDIZADEHAGHDAM, MILPITAS, CA (US); THARAK VANGALAPAT, QUINCY, MA (US); NAM CHIN CHO, PEACHTREE CITY, GA (US)

(21) Appl. No.: 17/985,150

(22) Filed: Nov. 11, 2022

Related U.S. Application Data
(60) Provisional application No. 63/279,209, filed on Nov. 15, 2021.

(30) Foreign Application Priority Data
Nov. 23, 2021 (WO) 21209737.2

(51) Int. Cl. G06K 9/62; G06N 3/08

(52) U.S. Cl. CPC G06K 9/627; G06N 3/08

(57) ABSTRACT

A method of predicting a data point from a predictor, wherein the predictor comprises a trained machine which has been trained based on a training dataset comprising at least one labelled data point; wherein the method comprises: assigning a first function to the at least one labelled data point and a second function to the data point; determining a level of similarity based on a comparison of the first function and the second function; determining a similarity information between the at least one labelled data point and the data point; assigning a first weight to a prediction from the trained machine for the data point, and a second weight to the similarity information; determining an adjustment to the first and/or the second weight as a function of the level of similarity; and determining a prediction for the data point, wherein the prediction is based on combining the prediction from the trained machine with the adjusted first weight and the similarity information with the adjusted second weight.

### CROSS REFERENCE TO PRIOR APPLICATIONS

This patent claims the benefits of European Patent Application No. 21209737.2, filed on Nov. 23, 2021 and U.S. Application Ser. No. 63/279,209, filed Nov. 15, 2021. These applications are hereby incorporated by reference herein.

### FIELD OF THE INVENTION

The invention relates to a method of predicting a data point from a predictor. The invention further relates to a control device, a system, and a computer program product for predicting a data point from a predictor.

### BACKGROUND

Supervised learning is a class of machine learning algorithms which tries to learn the relationship between input and output using a large amount of labeled training data. It is generally a two-step process: In the first step, the system learns a model/function that can accurately map input to output from the available dataset. The goal of this step is to train a model which is able to generalize from the training data to unseen situations. Once the model is ready, in the second step, the model is deployed and is used to predict results for problems in real world. The deployed model generalizes the prediction for unseen data points.

U.S. Pat. No. 7,460,735B1 discloses a system which analyzes multiple images to identify similar images using histograms, image intensities, edge detectors, or wavelets. The system retrieves labels assigned to the identified similar images and selectively concatenates the extracted labels. The system assigns the concatenated labels to each of the identified similar images and uses the concatenated labels when performing a keyword search of the plurality of images.

### SUMMARY OF THE INVENTION

The inventors have realized that the step of training a model is not connected to the step of deployment of the trained model. The inventors have further realized that if a data point which has already been ‘seen’ by the trained model (i.e., which is comprised in the training dataset) is passed through the trained model, it may still not able to predict with 100% accuracy depending on how the model is trained. This can cause a lot of frustration to a user and reduce the overall usability of the trained model.

It is therefore an object of the present invention to improve the overall usability of trained models and further improve accuracy of predictions for data.

According to a first aspect, the object is achieved by a method of predicting a label for a data point from a predictor, wherein the predictor comprises a trained machine which has been trained based on a training dataset comprising at least one labelled data point; wherein the method comprises (the steps executed by a control device): assigning a first function to the at least one labelled data point and a second function to the data point; determining a level of similarity based on a comparison of the first function and the second function and/or based on a comparison of the at least one labelled data point and the data point; wherein the level of similarity is based on the common information between the first function and the second function and/or the at least one labelled data point and the data point; determining a similarity information between the at least one labelled data point and the data point, wherein the similarity information comprises labels of at least the common information between the data point and the at least one labelled data points; assigning a first weight to a prediction from the trained machine for the data point, and a second weight to the similarity information; determining an adjustment to the first and/or the second weight as a function of the level of similarity; and determining a prediction of a label for the data point, wherein the prediction is based on combining the prediction from the trained machine with the adjusted first weight and the similarity information with the adjusted second weight.

The method relates to predicting a label for a data point from a predictor. The prediction may comprise an output of an algorithm after it has been trained on a historical (training) dataset and applied to new data when forecasting the likelihood of a particular outcome. The data may comprise one or more of an audio data, a text data, a time series, an image, a video etc. The data point may comprise at least a (singular) data point from the data, e.g., at least an (single) image from a set of images etc. In other words, the data point may comprise at least a single piece of information. In machine learning, the data point is referred to as (at least) a single data point from the data set.

The predictor may comprise a model or an algorithm trained for predicting the outcome for the data. The outcome may comprise a label for the data. The predictor may comprise a trained machine which has been trained based on a training dataset comprising at least one labelled data point. Training a machine may comprise supervised learning which is the machine learning task of learning a function or model that maps an input to an output based on an input-output data pairs. It infers a function from a labeled training dataset comprising of a set of training data.

The method comprises assigning a first function to the at least one labelled data point and a second function to the data point. The first function may be assigned to each of the at least one labelled data point in the training dataset. In an example, the first and the second functions are the same. The definition of the first and the second functions may be not unique, and the selection of both functions may depend, e.g., on the type of training dataset (images, text etc.), amount of data in the training dataset etc. In an example, the purpose of the first and the second function is to transform the data point and the at least one labelled data point to a transformed domain for a valid comparison. The first and/or the second function may be the at least one labelled data point and the data point respectively, e.g., the functions are the (lebelled) data point and for instance thus don't transform the at least one labelled data point and/or the data point to a different (vector/function) space.

The method may further comprise determining a level of similarity based on the comparison of the first function and the second function and/or a level of similarity based on the comparison of the labelled data point and the data point. The step of determining a level of similarity may further comprise a sub-step of comparing the first function and the second function and/or the labelled data point and the data point and assigning a metric for the comparison. The level of similarity may be based on the common information between the first function and the second function and/or the at least one labelled data point and the data point. The common information may comprise an overlap between the labelled data point and the data point and/or between the functions. The selection of the metric may be based on the selected function, data type etc. Based on the comparison, a level of similarity may be determined. A level of similarity may comprise a value, e.g., between 0 and 1, wherein 1 represents the most similar data and 0 presents no similarity. Any other definition of level of similarity is not excluded. In an example, the step of determining the level of similarity comprises all the necessary steps to determine the level of similarity, e.g., including the comparison step, assigning a metric step etc. The comparison may be based on comparing the first function of (each of) the at least one labelled data point with the second function of the data point. For example, if there are 100 labelled data points, and 1 data point, thus the comparison involves comparing 100 labelled points with 1 data point.

The method further comprises determining a similarity information between the at least one labelled data point and the data point. In an example, the similarity information may comprise information which is common to the data point and the at least one labelled data point. In another example, the similarity information may comprise ‘labels’ of the common information in the data point and the at least one labelled data points. The labels may be determined from the at least one labelled data point. Since, the similarity information is based, e.g., on the comparison (or on the level of similarity) between the at least one data point and that data point, the similarity information may be a vector of information wherein one or more elements of the vector is the information related to each comparison. For instance, for an image data, the common information may be a part of the image, which is present in both the images. For a time-series data, the common information may be a subset of time-series which contains similar information. Similarity may be a literal matching, overlap, or related items, whereas the similarity information may be labels to that matched, overlap, or related item.

The method further comprises assigning a first weight to a prediction from the trained machine for the data point, and a second weight to the similarity information, and further comprises determining an adjustment to the first and/or the second weight as a function of the level of similarity. In an example, determining an adjustment may comprise zero change, i.e., the weights are adjusted with zero change. In alternative examples, either the first and the second or both the first and the second weights are adjusted. The adjustment may be determined as a function of the level of similarity and/or of the similarity information.

Since, the method further comprises determining a prediction for the data point, wherein the prediction is based on combining the prediction from the trained machine with the adjusted first weight and the similarity information with the adjusted second weight, information from the training dataset is included in the prediction, thus improving the accuracy of predictions for data. For example, if the data point is also present in the training dataset, the prediction can be directly based on the similarity information (comprising labels for the data point) and less from the prediction of the trained machine.

In an embodiment, the sum of the first and the second weight may be less than or equal to a predetermined maximum value of the first or the second weight.

In an example, the predetermined maximum value of the first or the second weight may be 1, therefore the sum of the two weights, in an example, be less than or equal to 1, i.e., w1+w2≤1. With such a selection of the predetermined maximum value and the sum, the step of determining the adjustment of the first and the second weight is improved.

In an embodiment, the at least one labelled data point and the data point may comprise one or more images, wherein the at least one labelled data point may comprise an area A; and the data point may comprise N samples from an area C; wherein k be the number of samples that are common to A and C, and wherein the level of similarity (ρ) may comprise ρ=k/N.

The level of similarity may be defined in terms of overlapping contents of two images. The images may be a 2D image or a 3D image. The area may be defined as the space occupied by the surface of an object or any (flat) shape. For example, area may be defined as a product of length and width. Different definitions of area for different shapes are known in the art of geometry and mathematics, which is not excluded and, for the sake of brevity, not further discussed here. The area may be divided into samples. If the overlapping samples are denoted by k and the total sample is N, then the level of similarity may be defined as ρ=k/N. For example, if there is no overlap, such that k=0, then the level of similarity is zero, i.e., ρ=0/N=0. Similarly, if two images completely overlap, therefore, k=N, then the level of similarity is 1, i.e., ρ=N/N=1. Further definitions of the level of similarity are not excluded.

In an embodiment, the method may further comprise if the level of similarity exceeds a first threshold, determining an adjustment for the first weight to be smaller than the second weight.

In this example, if two images are similar, e.g., in the case when the data point, at least partially, overlaps with the at least one labelled data point, more weight is advantageously given the similarity information compared to the prediction from the trained machine. In this way, prediction accuracy is further improved, since the at least one labelled data point which is similar to the data point already has a label attached to it, making the prediction more accurate.

In an embodiment, the method may further comprise: if the level of similarity does not exceed the first threshold, determining an adjustment for the first weight to be larger than the second weight.

If the level of similarity does not exceed the first threshold, i.e., there is low to no similarity between the data point and the at least one labelled data point, the label(s) of the labelled data point can not be used for prediction, therefore, the method advantageously adjust the first weight to be larger than the second weight such that the prediction from the trained machine is given a higher weight.

In an embodiment, the at least one labelled data point and the data point may comprise one or more satellite images, and the prediction from the predictor may comprise predicting one or more lighting poles in the one or more satellite images.

In this example, the data comprises one or more satellite images. The satellite images are images of Earth collected by imaging satellites operated by governments and businesses around the world. The satellite images may comprise images of different streets of a city. In this example, one of the tasks for a predictor may be to identify lighting poles (streetlights) in a given area of interest from the satellite images. This reduces the effort for users to manually search the (street)light in maps and makes it more user-friendly.

In an embodiment, the first and the second function may comprise a hash function based on latitude and longitude information of the one or more satellite images.

One of the definitions for the first and the second function may comprise a hash function. Each image may be identified using its latitude (l) and longitude (w) coordinates. Therefore, hash function h may be defined as:

(l₁,w₁,l₂,w₂)=h(xᵢ),∀i∈(1, . . . ,N)

Such a definition of hash function allows a valid comparison between the data point and the at least one labelled data point. Other definitions of the hash function are not excluded.

In an embodiment, the level of similarity may be based on an overlap of lighting poles in the data point and the at least one labelled data point satellite images.

For the example of satellite images and for the problem of identifying one or more lighting poles (streetlights) in the image, the number of poles identified in both the data point and the at least one labelled data point may define the level of similarity. For example, higher the number of common lighting poles, larger the level of similarity.

In an embodiment, the method may further comprise determining an overlap between the data point and the at least one data point satellite images, determining the number of the one or more lighting poles in the overlapped region, determining the adjustment to the first and the second weight based on the determined number of the one or more lighting poles.

The method may comprise determining an overlap between the satellite images and counting the number of lighting poles in the overlapped region. Since, the weights are adjusted based on the determined number of lighting poles, the accuracy of the prediction is further improved. The method may comprise increasing the weight for the similarity information (e.g., information related to the shared lighting poles in both images) for the lighting poles common in the overlap region such that the prediction is directly based on the similarity information and increasing the weight for the prediction from the trained machine for the remaining lighting pole(s) in the data point.

In an embodiment, the method may further comprise if the level of similarity exceeds the first threshold and if a confidence of prediction from the trained machine does not exceed a confidence threshold, retraining the trained machine.

In this example, the machine is retained to further improve the prediction accuracy if the level of similarity exceeds the first threshold and if a confidence of prediction from the trained machine does not exceed a confidence threshold. The confidence threshold may be predetermined.

In an embodiment, the trained machine has been further trained based on a test dataset; and wherein the test dataset comprises at least on labelled test data point; wherein the method comprises: assigning a third function to the at least one labelled test data point; determining a level of test similarity based on a comparison of the second function and the third function; determining a test similarity information between the at least one labelled test data point and the data point; assigning a third weight to the test similarity information; determining an adjustment to the second and/or the third weight as a function of the level of test similarity; and determining a prediction for the data point, wherein the prediction is based on combining the prediction from the trained machine with the adjusted first weight and the test similarity information with the adjusted third weight.

Similar to the training dataset, test dataset may be used for the comparison. Since, the test dataset has also been ‘seen’ by the trained machine and is also labelled, any similarity with the test data may be exploited (e.g., by using the label of the similar image) to increase prediction accuracy.

According to a second aspect, the object is achieved by a control device for predicting a data point from a predictor, wherein the predictor comprises a trained machine which has been trained based on a training dataset comprising at least one labelled data point; wherein the control device comprises a processor arranged for executing at least some of the steps of method according to the first aspect.

According to a third aspect, the object is achieved by a system for predicting a data point from a predictor, wherein the predictor comprises a trained machine which has been trained based on a training dataset comprising at least one labelled data point; wherein the system comprises: the training dataset and/or a test dataset; a comparator for determining a level of similarity and/or similarity information between the at least one labelled data point and the data point; a control device according to the second aspect.

According to a fourth aspect, the object is achieved by a computer program product comprising instructions which, when the program is executed by a computer, cause the computer to carry out the steps of the method of the first aspect.

It should be understood that the computer program product, the control device, and the system may have similar and/or identical embodiments and advantages as the above-mentioned methods.

### BRIEF DESCRIPTION OF THE DRAWINGS

The above, as well as additional objects, features and advantages of the disclosed systems, devices and methods will be better understood through the following illustrative and non-limiting detailed description of embodiments of systems, devices and methods, with reference to the appended drawings, in which:

FIG. 1 shows schematically and exemplary an embodiment of a system for predicting a data point from a predictor;

FIGS. 2a, 2b, and 2c show schematically and exemplary another embodiment of a system for predicting a data point from a predictor;

FIG. 3 shows schematically and exemplary a flowchart illustrating an embodiment of a method for predicting a data point from a predictor; and

FIG. 4 shows schematically and exemplary an embodiment of a control device for predicting a data point from a predictor;

All the figures are schematic, not necessarily to scale, and generally only show parts which are necessary in order to elucidate the invention, wherein other parts may be omitted or merely suggested.

### DETAILED DESCRIPTION OF EMBODIMENTS

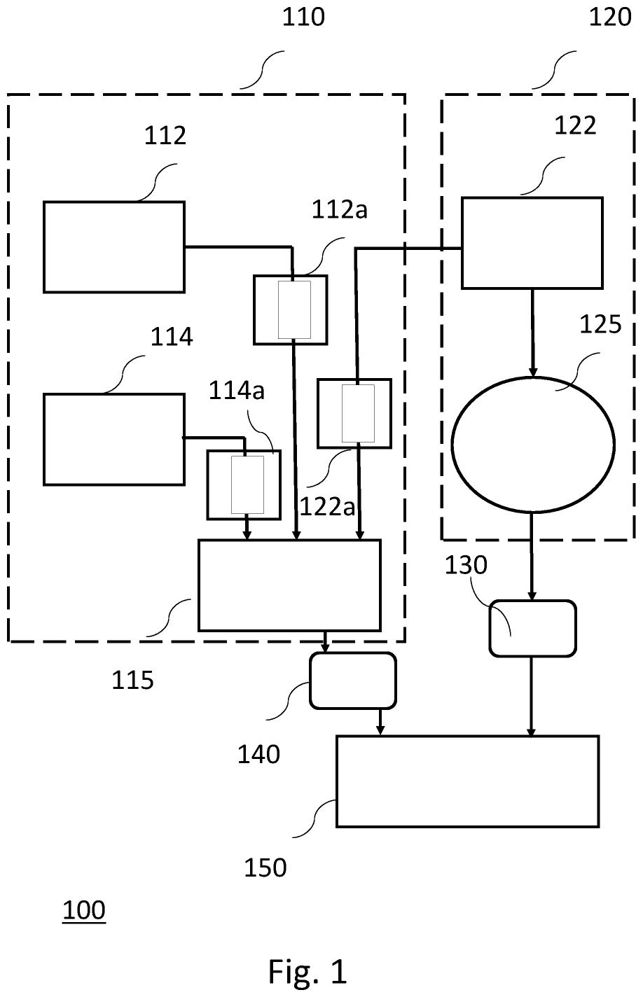

FIG. 1 shows schematically and exemplary an embodiment of a system 100 for predicting a data point from a predictor 150. Learning algorithms involve learning the relationship between input and output using (a large amount of) labeled training data. Usually, a large amount of labelled training data is used, but for some algorithms such as one-shot learning e.g., for image processing such as face recognition, aims to learn information about object categories from one, or only a few, training samples/images. Learning is generally a two-step process: In the first step, the system learns a model/function that can accurately map input to output from the available dataset. The goal of this step is to train a model/machine which is able to generalize from the training data to unseen situations. Once the model/machine is ready, in the second step, the model/machine is deployed and is used to predict results for problems in real world. The system or architecture 100 is related to the deployment phase for predicting a data point 122. In this example, the system 100 exemplary shows a deployment of a trained machine 125 which has been trained based on a training dataset 112, and (optionally) further validated based on a test dataset 114. The training dataset 112 and the test dataset 114 comprise at least one labelled data point. Usually in machine learning, the training dataset 112 and the test dataset 114 comprise different labelled data points.

Training a machine may comprise supervised learning which is the machine learning task of learning a function or model that maps an input to an output based on an input-output data pairs. It infers a function from a labeled training dataset comprising of a set of training data. In supervised learning, each sample in the training dataset is a pair consisting of an input (e.g., a vector) and a desired output value (e.g., label). The training dataset comprises the output and the input. A supervised learning algorithm, such as support vector machine (SVM), decision tree (random forest), deep neural networks etc., analyzes the training dataset and produces an inferred function or model, which can be used for making predictions based on a new dataset. Additionally, and/or alternatively, other machine learning algorithms such as clustering, dimensionality reduction etc., may be used for training the machine.

The data may comprise one or more of an audio data, a text data, a time series, an image, a video etc. The algorithm used for training the machine may be related to the type of data, the amount of data, a required accuracy etc. For example, for text data, algorithms from natural language processing (NLP) such as Recurrent Neural Network (RNN), Long Short-Term Memory Cell (LSTM) may be used. For image data, algorithms from image processing such as Convolutional Neural Network (CNN) may be used. It is to be understood that there is a wide overlap of algorithms for different data types and the selection of a particular algorithm is on case-by-case basis. It is to be further understood that the training algorithms, e.g., in machine learnings, are very well-known and hence are not further discussed.

The system 100 is an architecture of prediction for a data point 122. The system 100 comprises two sections 110, 120, i.e., the left section 110 and the right section 120. The predictor 150 comprises weighted 130,140 contribution from the left section 110 and the right section 120. The right section 120 is a (typical) deployment of a trained machine 125, wherein a new data point 122 is passed through the trained machine 125 and the trained machine 125 is arranged for predicting the new data point 122, e.g., identifying a class of the new data point 122. Therefore, the contribution from the right section 120 is the prediction from the trained machine 125 for the data point 122. This contribution is weighted by the first weight 130 in the final prediction by the predictor 150.

The left section 110 comprises a training dataset 112 and a test dataset 114, which have been used during the training phase for training the machine. The at least one labelled data point in the training dataset 112 and the test dataset 114 is assigned a first and a third function 112a, 114a respectively. A second function 122a is also assigned to the data point 122. A function is a mapping from an input to an output. In the simplest form, the at least one labelled data point and the data point is mapped to the least one labelled data point and the data point respectively, i.e., ƒ(x)=x. Other definitions of functions known in the field of mathematics are not excluded. The purpose of the first, the second, and the third function is to transform the data point and the at least one labelled data point to a transformed domain for a (valid or logical) comparison.

The system 100 comprises a comparator 115 which is arranged for determining a level of similarity and similarity information between the at least one labelled data point and the data point 122. For example, if the data is text data, and the function is ƒ(x)=x, then the comparison may be to determine similar text in both the data point 122 and the at least one labelled data from the training dataset 122 and/or test dataset 114. The similarity of the at least one labelled data point and the data point 122 such as an overlapping text determines the level of similarity. The similarity information may comprise the label for the overlapping text. The similarity information is assigned a second weight 140.

The comparator 115 may further arranged for determining an adjustment to the one or more of the first weight 112a, the second weight 122a, and the third weight 114a as a function of the level of similarity. The system 100 further arranged for determining a prediction for the data point 122, wherein the prediction is based on combining the prediction from the trained machine 125 with the adjusted first weight 130 and the similarity information 115 with the adjusted second weight 140.

In an example, the determining an adjustment comprises determining zero change. The adjustment may be determined based on the similarity information and/or as a function of the level of similarity. For example, if the level of similarity exceeds a first threshold, i.e., the data point 122 is (at least partially) comprised in the training dataset 112, the first weight 130 may be determined to be smaller than the second weight 140, such that similarity information plays a higher role in the prediction. Alternatively, if the level of similarity does not exceed a first threshold, i.e., the data point 122 is not comprised in the training dataset 112, the first weight 130 may be determined to be larger than the second weight 140, such that the prediction from the trained machine plays a higher role in the prediction.

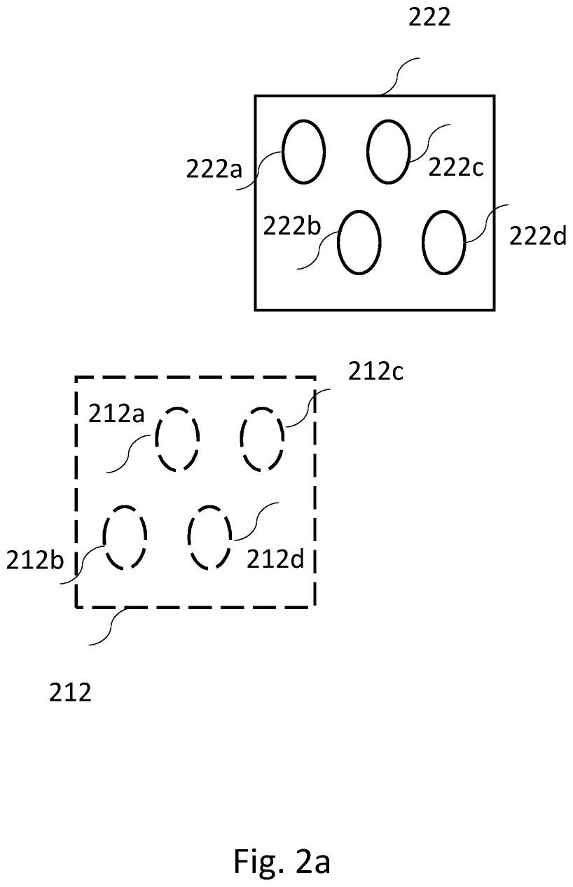

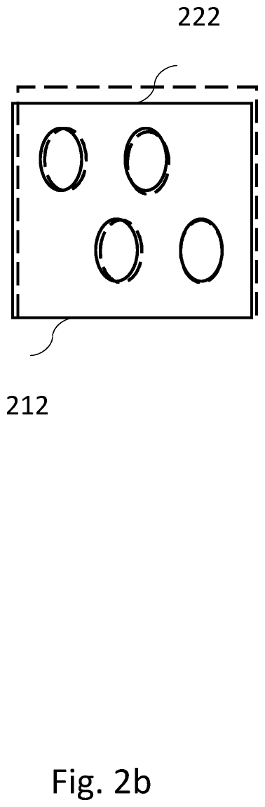

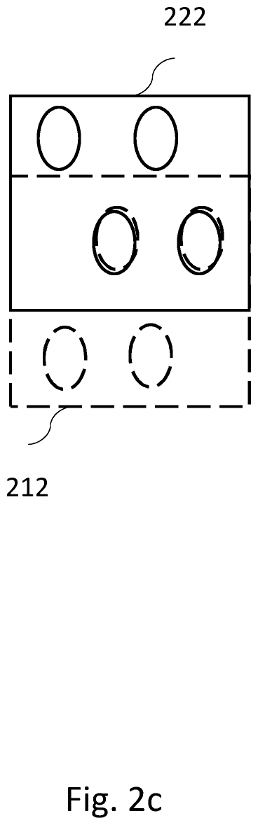

FIGS. 2a, 2b, and 2c show schematically and exemplary another embodiment of a system 100 for predicting a data point from a predictor 150. In these examples, the at least one labelled data point and the data point 222 comprise one or more satellite images 212, 222, and the prediction from the predictor comprises predicting one or more lighting poles 212a-d, 222a-d in the one or more satellite images 212, 222. In these examples, the comparison of only one of the at least one labelled data point 212 with the data point 222 is shown.

In this example, the first and the second function comprise a hash function based on latitude and longitude information of the one or more satellite images 212, 222. The definition of the hash function may be based for example on a type of data, amount of data etc. For the problem of identifying streetlights using satellite images, latitude-longitude values for the top left and bottom right coordinates of (each of) the at least one labelled data point 212 and the data point 222 have been considered. The hash function transforms the image into a transformed domain. As mentioned, each image will be identified using its latitude (l) and longitude (w) coordinates. Therefore, hash function h is defined as:

(l₁,w₁,l₂,w₂)=h(xᵢ),∀i∈(1, . . . ,N)

In order to compare and identify similar images (in the transformed domain), a metric m may be defined as follows:

$$\begin{matrix}m ( h ( {x}_{1} ) , h ( {x}_{2} ) ) = 1 , if {x}_{1} = {x}_{2} \\ = k , if {x}_{1} ∼ {x}_{2} \\ = 0 , if {x}_{1} \neq {x}_{2}\end{matrix}$$

Where k is [0,1]. Higher the level of similarity, the greater the score and vice versa.

The level of similarity is based on an overlap of lighting poles 212a-d, 222a-d in the data point 222 and the at least one labelled data point 212 satellite images. In this example, the at least one labelled data point 212 comprises an area A; and the data point 222 comprises N samples from an area C; wherein k be the number of samples that are common to A and C, and wherein the level of similarity (ρ) comprises: ρ=k/N

$$ρ = \frac{k}{N} .$$

If area A and C are completely overlapping, k=N, therefore,

$$ρ = \frac{N}{N} = 1 .$$

If area A and C are not completely overlapping, k=0, therefore,

$$ρ = \frac{0}{N} = 0 .$$

The level of similarity and the similarity information may be determined based on an overlap between the data point 222 and the at least one data point 212 satellite images. The number of the lighting poles in the overlapped region may be determined and the adjustment to the first and the second weight may be determined based on the determined number of the lighting poles.

In FIG. 2a, the two images 212, 222 are not similar. It is shown that there is no overlapping region and thus there is no lighting poles (streetlights) 212a-d, 222a-d common to both images. Therefore, the level of similarity may be ρ=0. The similarity information may comprise an empty vector. In an example, the similarity information may be determined when the level of similarity is above a predetermined threshold, i.e., ρ>0. In this case, the second weight 140 may be assigned low to zero weight and the prediction is based on the prediction from the trained machine 125.

In FIG. 2b the two images 212, 222 are completely overlapping, therefore ρ=1. For the sake of clarity, the reference signs to the lighting poles 212a-d, 222a-d are removed in FIG. 2b and FIG. 2c. In the case as shown in FIG. 2b, all the lighting poles 212a-d, 222a-d are common to both images. The similarity information may comprise all the lighting poles 212a-d, 222a-d and the respective labels. In this case, the maximum weight may be assigned the second weight 140 and the prediction is based on the prediction from the similarity information. It is advantageous since the labels for the lighting poles 212a-d, 222a-d are already available via the at least one labelled data point 212.

In FIG. 2c the two images 212, 222 are partially overlapping, therefore ρ=0.5. In this case, the lighting poles 222b, 222d of the data point 222 is common to the lighting poles 212a, 212c. The similarity information may comprise the common lighting poles, i.e., 222b, 222d and 212a, 212c, and the respective labels. In this case, the second weight 140 and the first weight 130 may be assigned equal weights such that the prediction for the similar lighting poles 222b, 222d and 212a, 212c may be from the similarity information and the prediction for the remaining lighting poles 222a, 222c and 212b, 212d may be based on the prediction from the trained machine 125.

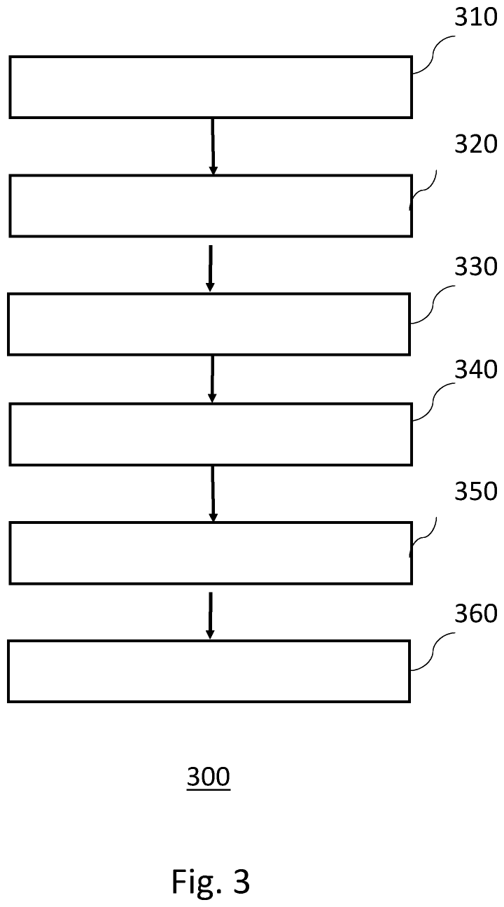

FIG. 3 shows schematically and exemplary a flowchart illustrating an embodiment of a method 300 for predicting a data point from a predictor 150. The method 300 comprises assigning 310 a first function to the at least one labelled data point 212 and a second function to the data point 222. The method 300 may further comprise determining 320 a level of similarity based on a comparison of the first function and the second function. The step of determining 320 may comprise the sub steps of defining a metric for the comparison, comparing the first function and the second function, and then determining a level of similarity based on the comparison.

The method 300 determining 330 a similarity information between the at least one labelled data point 212 and the data point 222. In an example, the similarity information may comprise information which is common to the data point 222 and the at least one labelled data point 212. In another example, the similarity information may comprise labels of the similar points. The labels are determined from the at least one labelled data point. The method 300 further comprises assigning 340 a first weight 130 to a prediction from the trained machine 125 for the data point 122, 222, and a second weight 140 to the similarity information. The weights may be a vector of 1's and 0's, wherein the number of elements for the weight vector is equal to the number of classes to be identified. For example, for the first weight 130 1's is assigned to the classes which is to be predicted/identify by the trained machine 125, and 0's to the classes which is to be predicted/identify by the similarity information. In an example, the sum of the first 130 and the second weight 140 (e.g., for each row) is less than or equal to a predetermined maximum value of the first 130 or the second weight 140. In the simplest example, weights may be defined as a respective contribution of the similarity information and the prediction from the trained machine.

The method 300 further comprises determining 350 an adjustment to the first 130 and/or the second weight 140 as a function of the level of similarity. In an example, the determining an adjustment may comprise zero change, i.e., the weights are adjusted with zero change. In alternative examples, either the first and the second or both the first and the second weights are adjusted. The adjustment may be determined as a function of the level of similarity and/or of the similarity information.

The method 300 further comprises determining 360 a prediction for the data point 122, 222, wherein the prediction is based on combining the prediction from the trained machine 125 with the adjusted first weight 130 and the similarity information with the adjusted second weight 140. For example, if the data point 122, 222 is also present in the training dataset 112 or in the test dataset 114, the labels for the data point 122, 222 may be directly determined from the common point in the training and/or test dataset, and the prediction maybe based directly from the determined common points.

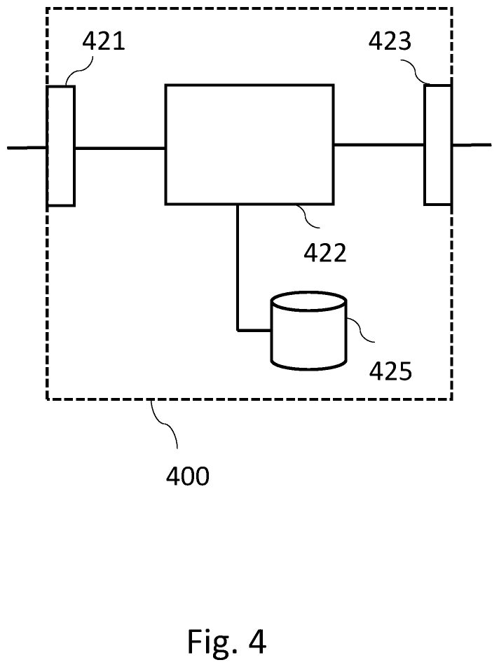

FIG. 4 shows schematically and exemplary an embodiment of a control device 400 for predicting a data point from a predictor 150. The control device 210 may comprise an input unit 421 and an output unit 423. The control device 400 may further comprise a memory 425 which may be arranged for storing training dataset 112 and/or test dataset 114. The memory 425 may be further arranged for storing the trained machine 125. The control device 400 may comprise a processor 422 arranged for training the machine based on the training dataset 112 and further arranged for training the machine on the test dataset 114. The test dataset 114 may be used for validation purposes. The processor 422 may be further arranged for assigning a first function to the at least one labelled data point 212 and a second function to the data point 122, 222; determining a level of similarity based on a comparison of the first function and the second function; determining a similarity information between the at least one labelled data point 212 and the data point 122,222; assigning a first weight 130 to a prediction from the trained machine 125 for the data point 122,222, and a second weight 140 to the similarity information; determining an adjustment to the first 130 and/or the second weight 140 as a function of the level of similarity; and determining a prediction for the data point 122,222, wherein the prediction is based on combining the prediction from the trained machine 125 with the adjusted first weight 130 and the similarity information with the adjusted second weight 140.

The control device 400 may be implemented in a unit separate from the lighting poles 222a-d, 212a-d, such as wall panel, desktop computer terminal, or even a portable terminal such as a laptop, tablet or smartphone. Alternatively, the control device 400 may be incorporated into the same unit as one of the lighting poles 222a-d, 212a-d. Further, the control device 400 may be implemented in an environment or remote from the environment (e.g. on a server); and the control device 400 may be implemented in a single unit or in the form of distributed functionality distributed amongst multiple separate units (e.g. a distributed server comprising multiple server units at one or more geographical sites, or a distributed control function distributed amongst the lighting poles 222a-d, 212a-d). Furthermore, the control device 400 may be implemented in the form of software stored on a memory (comprising one or more memory devices) and arranged for execution on a processor (comprising one or more processing units), or the control device 400 may be implemented in the form of dedicated hardware circuitry, or configurable or reconfigurable circuitry such as a PGA or FPGA, or any combination of these.

The method 300 may be executed by computer program code of a computer program product when the computer program product is run on a processing unit of a computing device, such as the processor 422 of the control device 400.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer or processing unit. In the device claim enumerating several means, several of these means may be embodied by one and the same item of hardware. The mere fact that certain measures are recited in mutually different dependent claims does not indicate that a combination of these measures cannot be used to advantage.

Aspects of the invention may be implemented in a computer program product, which may be a collection of computer program instructions stored on a computer readable storage device which may be executed by a computer. The instructions of the present invention may be in any interpretable or executable code mechanism, including but not limited to scripts, interpretable programs, dynamic link libraries (DLLs) or Java classes. The instructions can be provided as complete executable programs, partial executable programs, as modifications to existing programs (e.g., updates) or extensions for existing programs (e.g. plugins). Moreover, parts of the processing of the present invention may be distributed over multiple computers or processors or even the ‘cloud’.

Storage media suitable for storing computer program instructions include all forms of nonvolatile memory, including but not limited to EPROM, EEPROM and flash memory devices, magnetic disks such as the internal and external hard disk drives, removable disks and CD-ROM disks. The computer program product may be distributed on such a storage medium, or may be offered for download through HTTP, FTP, email or through a server connected to a network such as the Internet.

1. A method of predicting a label for a data point from a predictor, wherein the predictor comprises a trained machine which has been trained based on a training dataset comprising at least one labelled data point; wherein the method comprises the steps executed by a control device:
assigning a first function to the at least one labelled data point and a second function to the data point;
determining a level of similarity based on a comparison of the first function and the second function and/or based on a comparison of the at least one labelled data point and the data point; wherein the level of similarity is based on the common information between the first function and the second function and/or between the at least one labelled data point and the data point;
determining a similarity information between the at least one labelled data point and the data point; wherein the similarity information comprises labels of at least the common information between the data point and the at least one labelled data points,
assigning a first weight to a prediction from the trained machine for the data point, and a second weight to the similarity information;
determining an adjustment to the first and/or the second weight as a function of the level of similarity; and
determining a prediction of a label for the data point, wherein the prediction is based on combining the prediction from the trained machine with the adjusted first weight and the similarity information with the adjusted second weight.

2. The method according to claim 1, wherein the sum of the first and the second weight is less than or equal to a predetermined maximum value of the first or the second weight.

3. The method according to claim 1, wherein the at least one labelled data point and the data point comprise one or more images, wherein the at least one labelled data point comprises an area A; and the data point comprises N samples from an area C; wherein k be the number of samples that are common to A and C, and wherein the level of similarity (ρ) comprises: ρ=k/N.

4. The method according to claim 1, wherein the method further comprises: if the level of similarity exceeds a first threshold,
determining an adjustment for the first weight to be smaller than the second weight.

5. The method according to claim 1, wherein the method further comprises: if the level of similarity does not exceed the first threshold,
determining an adjustment for the first weight to be larger than the second weight.

6. The method according to claim 1, wherein the at least one labelled data point and the data point comprise one or more satellite images, and the prediction from the predictor comprises predicting one or more lighting poles in the one or more satellite images.

7. The method according to claim 6, wherein the first and the second function comprise a hash function based on latitude and longitude information of the one or more satellite images.

8. The method according to claim 7, wherein the level of similarity is based on an overlap of lighting poles in the data point and the at least one labelled data point satellite images.

9. The method according to claim 6, wherein the method further comprises:
determining an overlap between the data point and the at least one data point satellite images,
determining the number of the one or more lighting poles in the overlapped region,
determining the adjustment to the first and the second weight based on the determined number of the one or more lighting poles.

10. The method according to claim 1, wherein the method further comprises: if the level of similarity exceeds the first threshold and if a confidence of prediction from the trained machine does not exceed a confidence threshold,
retraining the trained machine.

11. The method according to claim 1, wherein the trained machine has been further trained based on a test dataset; and wherein the test dataset comprises at least on labelled test data point; wherein the method comprises:
assigning a third function to the at least one labelled test data point;
determining a level of test similarity based on a comparison of the second function and the third function;
determining a test similarity information between the at least one labelled test data point and the data point;
assigning a third weight to the test similarity information;
determining an adjustment to the second and/or the third weight as a function of the level of test similarity; and
determining a prediction for the data point, wherein the prediction is based on combining the prediction from the trained machine with the adjusted first weight and the test similarity information with the adjusted third weight.

12. A control device for predicting a data point from a predictor, wherein the predictor comprises a trained machine which has been trained based on a training dataset comprising at least one labelled data point; wherein the control device comprises a processor arranged for executing at least some of the steps of method according to claim 1.

13. A system for predicting a data point from a predictor, wherein the predictor comprises a trained machine which has been trained based on a training dataset comprising at least one labelled data point; wherein the system comprises:
the training dataset and/or a test dataset;
a comparator for determining a level of similarity and similarity information between the at least one labelled data point and the data point;
a control device according to claim 12.

14. A computer program product comprising instructions which, when the program is executed by a computer, cause the computer to carry out the steps of the method of claim 1.
